(19) United States
(12) Patent Application Publication
(10) Pub. No.: US 2010/0116139 A1
(43) Pub. Date: May 13, 2010

(54) Chain protector for a linear motion processing machine

(76) Inventor: Chang-Cheng Ho, Taichung (TW)

Correspondence Address: Dr. BANGER SHIA;Patent Office of Bang Shia, 102 Lindencrest Ct., Sugar Land, TX, 77479-5201, US

(21) Appl. No.: 12/268,951

(22) Filed: Nov. 11, 2008

(51) Int. Cl. B01D 46/12

(52) U.S. Cl. 96/121; 95/284; 55/350.1

(57) ABSTRACT

A chain protector for a linear motion processing machine comprises a first protecting assembly and a second protecting assembly. The first protecting assembly includes a holding space for accommodation of a chain, and the second protecting assembly includes a limiting space for accommodation of the first protecting assembly. The chain is protected by the first protecting assembly and the second protecting assembly that are made of different materials against the severe working environment. The first protecting assembly is connected to a negative pressure system by pipe to eliminate the dust generated by the mechanical operation, thus maintaining a clean work environment.

### BACKGROUND OF THE INVENTION

1. Field of the Invention

The present invention relates to a chain for a linear motion processing machine, and more particularly to a chain protector for a linear motion processing machine.

2. Description of the Prior Art

With the rapid development of technical industry, the chain used in a linear motion processing machine which has a strict requirement for clean work environment mainly employs a metal cover to protect pipelines or wires of the linear motion processing machine, in order to prevent mechanical movement from generating dust and maintain a clean work environment, but there is still some dust diffusing to affect the cleanliness.

The present invention has arisen to mitigate and/or obviate the afore-described disadvantages.

### SUMMARY OF THE INVENTION

The primary objective of the present invention is to provide a chain protector for a linear motion processing machine, which can provide a negative pressure type double-layer protection to the chain.

In order to achieve the above objective, the chain protector for a linear motion processing machine in accordance with the present invention comprises:

A first protecting assembly includes a first extension sleeve, a second extension sleeve and a connector. One end of the first extension sleeve and one end of the second extension sleeve are combined to two opposite ends of the connector, respectively. The connector communicates with the first extension sleeve and the second extension sleeve to define a holding space for accommodation of the chain. The holding space of the first protecting assembly is connected to a negative pressure system by pipe.

A second protecting assembly includes a base and plural covers, the first extension sleeve, the second extension sleeve and the connector of the first protecting assembly are arranged on the base, the other end of the first extension sleeve and the other end of the second extension sleeve are combined to two opposite ends of the base, the covers are covered on the base in such a manner that the first protecting assembly is held in the limiting space defined by the base and the covers.

Based on a further analysis, the present invention has the following advantages: the chain is protected by the first protecting assembly and the second protecting assembly that are made of different materials, so that the pipelines and wires in the chain can be protected against the severe environment to extend the service life, and the negative pressure system produces a negative pressure to absorb dust for avoiding polluting the working environment, thus maintaining a clean work environment.

### BRIEF DESCRIPTION OF THE DRAWINGS

FIG. 1 is a perspective view of a chain protector for a linear motion processing machine in accordance with the present invention;

FIG. 2 is a plane view of the chain protector for the linear motion processing machine in accordance with the present invention of FIG. 1; and

FIG. 3 is a schematic view illustrating an operational state of the linear motion processing machine in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

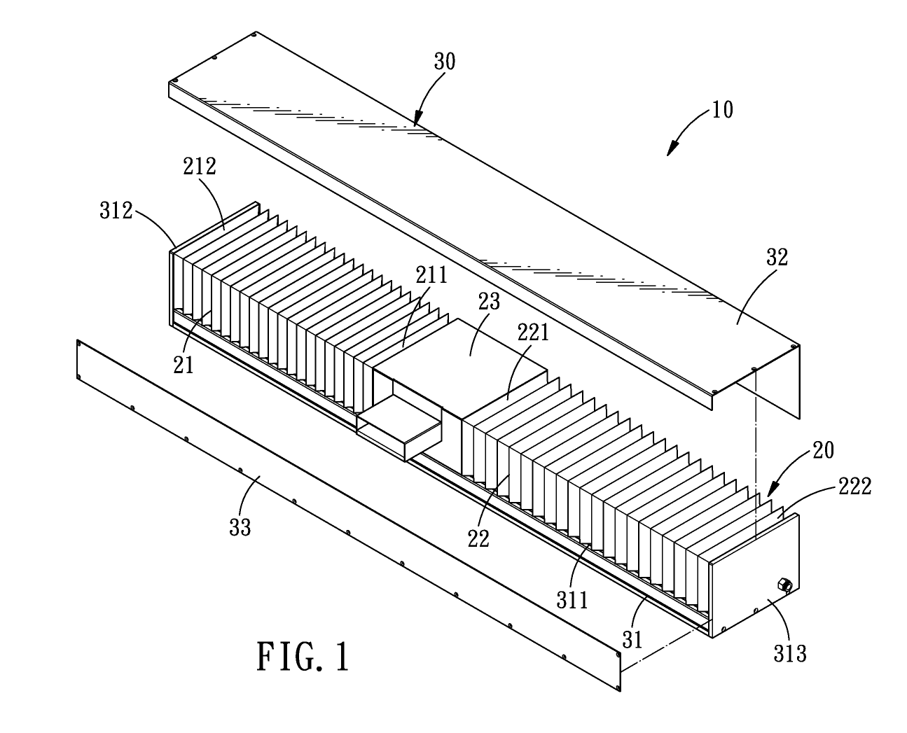

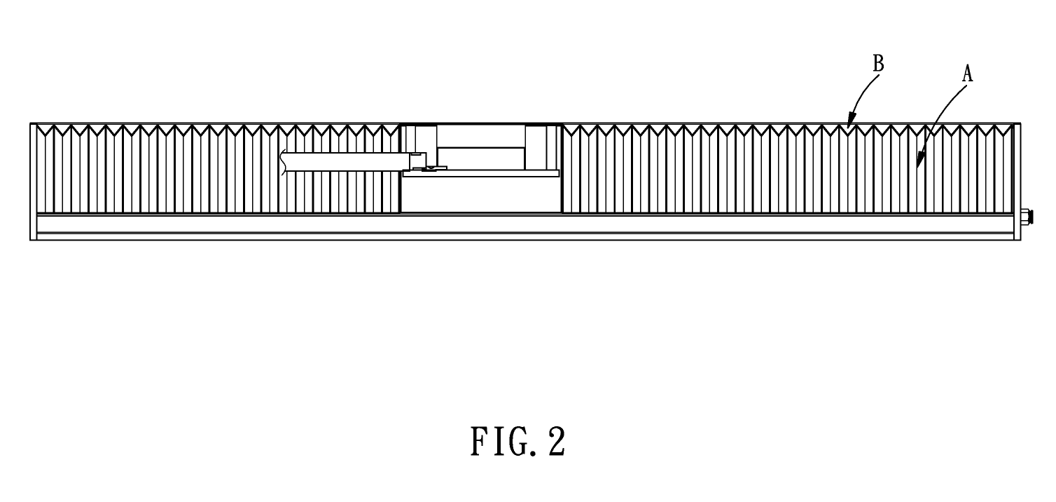

Referring to FIGS. 1-2, a chain protector 10 in accordance with a preferred embodiment of the present invention comprises a first protecting assembly 20, a second protecting assembly 30 and a negative pressure system 40.

The first protecting assembly 20 includes a first extension sleeve 21, a second extension sleeve 22 and a connector 23.

The first extension sleeve 21 is hollow and made of flexible material, such as Teflon. The first extension sleeve 21 is formed with a combining portion 211 and a positioning portion 212 at two opposite ends thereof.

The second extension sleeve 22 is hollow and made of flexible material, such as Teflon. The second extension sleeve 22 is formed with a combining portion 221 and a positioning portion 222 at two opposite ends thereof.

The connector 23 is made of metal material and in the form of a hollow rectangular structure. Two opposite ends of the connector 23 are combined to the combining portion 211 of the first extension sleeve 21 and the combining portion 221 of the second extension sleeve 22, respectively in such a manner that the connector 23 communicates with the first extension sleeve 21 and the second extension sleeve 22 to define a holding space A for accommodation of the chain.

The second protecting assembly 30 is made of metal material and includes a base 31, a first cover 32 and a second cover 33.

The base 31 is formed at one side thereof with a loading portion 311. The base 31 further includes a first positioning portion 312 and a second positioning portion 313 that are vertically formed at two opposite ends of the loading portion 311 and both in the form of a sheet. The first extension sleeve 21, the second extension sleeve 22 and the connector of the first protecting assembly 20 are arranged on the base 31 in such a manner that the positioning portion 212 of the first extension sleeve 21 is combined with the first positioning portion 312 of the base 31, and the positioning portion 222 of the second extension sleeve 22 is combined with the second positioning portion 313 of the base 31.

The first cover 32 is L-shaped in cross section, and the second cover 33 is in the form of an elongated sheet. The first cover 32 and the second cover 33 are covered on the base 31, respectively. Between one side edge of the first cover 32 and one side edge of the second cover 33 is preformed a limiting passage 34. The base 31, the first cover 32 and the second cover 33 of the second protecting assembly 30 define a limiting space B.

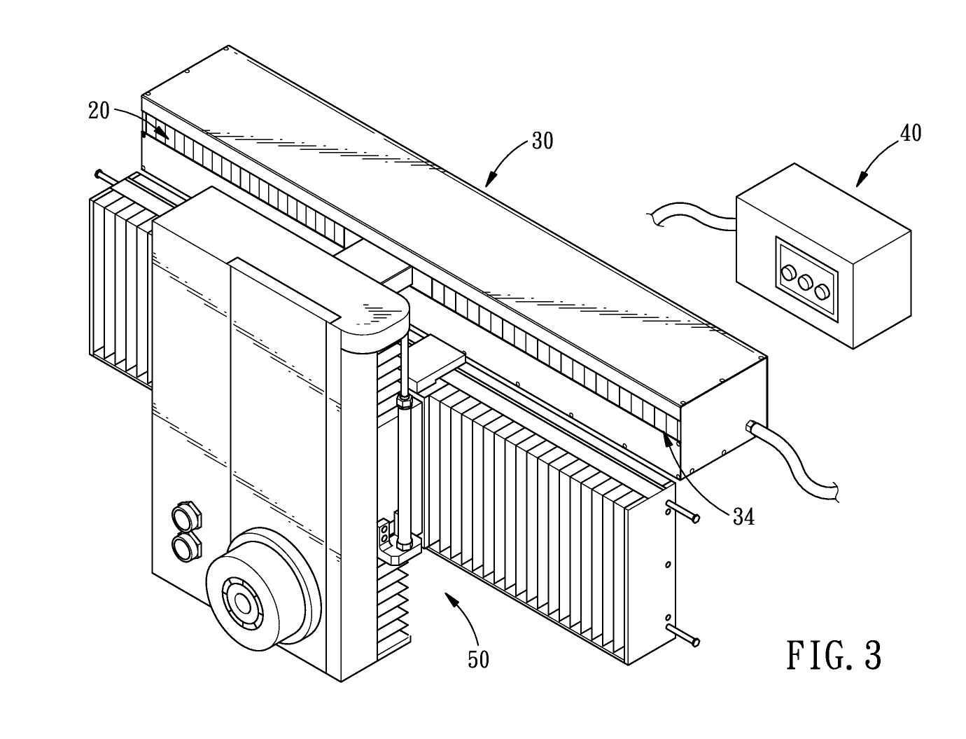

Referring to FIG. 3, the negative pressure system 40 is connected to the holding space A of the first protecting assembly 20 by pipe to perform the negative pressure operation to absorb dust.

The chain protector 10 is used in a linear motion processing machine 50, and the limiting passage 34 of the second protecting assembly 30 is provided for arrangement of wires or pipelines from the connector 23 of the first protecting assembly 20 to the linear motion processing machine 50.

While we have shown and described various embodiments in accordance with the present invention, it is clear to those skilled in the art that further embodiments may be made without departing from the scope of the present invention.

What is claimed is:

1. A chain protector for a linear motion processing machine comprising:
a first protecting assembly including a first extension sleeve, a second extension sleeve and an connector, the first extension sleeve being formed at two opposite ends thereof with a combining portion and a positioning portion, the second extension sleeve being formed at two opposite ends thereof with a combining portion and a positioning portion, two ends of the connector being combined to the combining portion of the first extension sleeve and the combining portion of the second extension sleeve in such a manner that the connector communicates with the first extension sleeve and the second extension sleeve to define a holding space for accommodation of a chain;
a second protecting assembly including a base and plural covers, the base being provided with a loading portion, the loading portion being provided at two opposite ends thereof with a first positioning portion and a second positioning portion, the first extension sleeve, the second extension sleeve and the connector of the first protecting assembly being arranged on the loading portion of the base, the positioning portion of the first extension sleeve being assembled to the first positioning portion of the base, the positioning portion of the second extension sleeve being assembled to the second positioning portion of the base, the covers being covered on the base, the base and the covers of the second protecting assembly defining a limiting space for accommodation of the first protecting assembly; and
a negative pressure system being connected to the holding space of the first protecting assembly through pipe to perform negative pressure operation.

2. The chain protector for a linear motion processing machine as claimed in claim 1, wherein the first extension sleeve of the first protecting assembly is made of Teflon, the second extension sleeve of the first protecting assembly is made of Teflon, the connector of the first protecting assembly is made of metal material.

3. The chain protector for a linear motion processing machine as claimed in claim 1, wherein the base of the second protecting assembly is made of metal material, and the covers of the second protecting assembly are made of metal material.
